(19) United States
(12) Patent Application Publication
(10) Pub. No.: US 2026/0133948 A1
(43) Pub. Date: May 14, 2026

(54) HYBRID STORAGE FOR CLUSTER-BASED VECTOR DATABASE

(71) Applicant: PayPal, Inc., San Jose, CA (US)

(72) Inventors: Yang Hu, Shanghai (CN); Ke Zheng, Shanghai (CN); Qin Qian, Shanghai (CN)

(21) Appl. No.: 18/866,423

(22) PCT Filed: Oct. 9, 2024
(86) PCT No.: PCT/CN2024/123730

§ 371 Date: Nov. 15, 2024

(51) Int. Cl. G06F 16/22; G06F 16/2455; G06F 16/28

(52) U.S. Cl. CPC G06F 16/2237; G06F 16/24554; G06F 16/285

(57) ABSTRACT

Methods and systems are presented for providing a framework for facilitating storage and querying of vectors. Under the framework, different portions of a vector database are stored in different types of memories to improve storage and querying efficiency. One or more index portions of the vector database is stored in a volatile memory, and one or more vector portions of the vector database is stored in a non-volatile memory. Each index portion includes an index that represents multiple levels of vector partitions, including a first level of vector partitions and a second level of vector partitions. Each vector partition in the first level of vector partitions is linked to a different subset of vector partitions in the second level of vector partitions, and each vector partition in the second level of vector partitions corresponds to a group of vectors.

### BACKGROUND

The present specification generally relates to computer-based database infrastructure, and more specifically, to a framework for providing a computer-based database for storing and querying vectors in association with an artificial intelligence model according to various embodiments of the disclosure.

### RELATED ART

Artificial intelligence (AI) models have been increasingly used by organizations to perform various complex tasks, such as to provide automated interactive services (e.g., a chatbot, an interactive voice response system, etc.), automated project management services, processing transactions, predicting fraud, and other tasks. Similar to other types of machine learning models, an AI model relies on pre-generated vectors (e.g., generated during the configuration and/or training phase) to produce outputs in response to various inquiries. A large number of vectors (e.g., hundreds of gigabytes of vectors, etc.) is typically required to support an AI model. It is a challenge to manage the storage and querying of such a large database of vectors. The problem is exacerbated when the AI model is required to provide responses within a short time frame (e.g., within 2 seconds, within 5 seconds, etc.), such as when determining whether to provide access to data or process an online transaction. Longer response times and/or inaccurate responses may lead to data loss, fraud, or other undesirable consequences. Thus, there is a need for an advanced framework for storing and querying a large vector database.

### BRIEF DESCRIPTION OF THE FIGURES

FIG. 1 is a block diagram illustrating an electronic transaction system according to an embodiment of the present disclosure;

FIG. 2 is a block diagram illustrating an AI module according to an embodiment of the present disclosure;

FIG. 3A illustrates an example indexing operation for generating a vector database according to an embodiment of the present disclosure;

FIG. 3B illustrates an example querying operation for querying a vector database according to an embodiment of the present disclosure;

FIG. 4 is a flowchart showing a process of indexing vectors according to an embodiment of the present disclosure;

FIG. 5 is a flowchart showing a process of querying a vector database according to an embodiment of the present disclosure;

FIG. 6 illustrates an example neural network that can be used to implement a machine learning model according to an embodiment of the present disclosure; and

FIG. 7 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a vector database framework that enables scalability and efficient storage and querying of vectors. As discussed herein, an artificial intelligence (AI) model performs tasks by accessing a large vector database that stores vectors associated with information that has been “learned” by the AI model. These vectors, as a whole, constitute the knowledge base of the AI model. Vectors (also referred to as “embeddings”) are representations of information. For example, when training data is fed into the AI model, the AI model may convert different portions of the information included in the training data into different vectors. The AI model may also convert contents from different data sources (e.g., the Internet, research centers, etc.) into vectors. The vectors generated by the AI model are associated with a vector space. The vector space may be multi-dimensional (e.g., hundreds, thousands of dimensions), where each dimension in the vector space represents a different aspect (e.g., different domains, different attributes, etc.) associated with the information that is provided to the AI model. Each vector may include values (e.g., numerical values) corresponding to the different dimensions of the vector space, such that a vector may correspond to a point within the vector space. As such, two pieces of information that are similar to each other may be represented by two vectors that are closer to each other within the vector space. Conversely, two pieces of information that are different from each other may be represented by vectors that are far away from each other within the vector space.

When an AI model receives a prompt (e.g., a query, a question, an instruction, etc.), the AI model may query the vector database for any vectors that are related to the prompt. The vectors retrieved from the vector database may enable the AI model to generate data (e.g., a response to the prompt). In order for the AI model to perform in an efficient manner (e.g., generating an accurate (within a threshold) response within a particular time frame, such as a few seconds, etc.), the AI model needs to be able to access and query vectors from the database quickly. Using a volatile memory (e.g., a random access memory of one or more computers) to store the vector database would generally provide the fastest access to the vectors for the AI model. However, since the typical size of a vector database for supporting an AI model is large (e.g., hundreds of gigabytes of data), it is often cost-prohibitive or impractical for the entire vector database to be stored and/or loaded into a volatile memory of a computer. On the other hand, if the vector database is stored in a non-volatile memory (e.g., hard disks, etc.), the slower speed for searching and loading data from a non-volatile memory could prevent the AI model from responding within the required time frame.

As such, according to various embodiments of the disclosure, a vector database framework may divide a vector database into multiple portions, such as an index portion that includes one or more indices associated with the vectors (or vector groups) of the vector database and a vector portion that includes the vectors. The index portion of the vector database includes only the indices, but does not include the vectors of the vector database. The indices are generated based on the vectors, and each index may represent logical partitions of the vectors in the vector database. Indexing the vectors into indices improves the efficiency of querying the vector database, since only the indices and a small portion of the vectors need to be processed (e.g., compared against a prompt or an input vector generated based on the prompt) during each query operation, without requiring all (or almost all) of the vectors to be processed, such as when querying using a brute force method.

The index portion only occupies a substantially small portion (e.g., 1%, 5%, etc.) of the overall size of the vector database. The indices are also accessed frequently by the AI model. For example, when the AI model receives a prompt, the AI model may compare the prompt (or a vector generated based on the prompt) against some or all of the indices to determine which vectors or vector groups are relevant (e.g., contribute to generating a response to the query) to the query. Due to the relatively small size and the access frequency of the indices, the vector database framework may store (or load) the index portion of the vector database to the volatile memory (e.g., a random access memory, etc.) of one or more computers to be accessed by the AI model.

The vector portion of the vector database includes all of the vectors associated with the vector database. With the use of the index of the vector database, only a small portion of the vectors is accessed during each query operation. In some embodiments, the vector database framework may store the vector portion of the vector database in a fast non-volatile memory (e.g., a solid-state drive, etc.) that is coupled with one or more computers. Since the index portion of the vector database represents only a substantially small portion of the overall size of the vector database, storing the entire index portion of the vector database in a volatile memory is both feasible and relatively affordable. Furthermore, since the majority of the data access (e.g., accessing the indices) occurs in the volatile memory, using the fast non-volatile memory to store the vectors does not significantly degrade the speed performance of the vector database.

In some embodiments, the vector database framework uses a clustering technique to generate the indices in the index portion of the vector database (even though other techniques can also be used to generate the index without departing from the spirit of the disclosure). For example, a computer system associated with the vector database framework may access vectors that are associated with an AI model. The computer system may perform a clustering operation on the vectors associated with the AI model. The clustering operation may assign vectors that are close to each other within the vector space to the same cluster (e.g., same partition), and assign vectors that are farther away from each other within the vector space to different clusters (e.g., different partitions), such that information represented by the vectors that is similar with each other are grouped within the same cluster (same partition).

In some embodiments, the computer system generates a value that represents each partition (e.g., a vector that represents the centroid of the cluster, etc.), and the value becomes a part of the index for the vector database. The computer system may also associate (link) the value representing each partition to the vectors within the corresponding partition. For example, the computer system may determine the memory addresses associated with the vectors that are stored in the non-volatile memory. The computer system may then store the memory addresses of the vectors within the same partition in association with a corresponding partition representation in the volatile memory. In some embodiments, the computer system may store vectors that are within the same partition close together within the non-volatile memory (e.g., within the same block of memory addresses) to further enhance the speed of retrieving the vectors within the same partition from the non-volatile memory.

In some embodiments, the computer system may generate the index portion of the vector database to represent multiple levels of partitions. When the vectors are divided into various partitions (e.g., using one or more clustering techniques), the partitions can be unevenly balanced. In other words, some of the partitions may include a substantially larger number of vectors than other partitions. The imbalance of different partitions may affect the performance of the vector database, as certain queries performed on the vector database may take substantially longer than other queries. In some embodiments, the multiple levels of partitions are generated to alleviate such an imbalance among partitions of vectors.

For example, the computer system may initially generate a first level of partitions by performing one or more clustering operations on the vectors (e.g., dividing the vectors into different partitions). The computer system may generate values (or representations, such as centroids of the clusters) that represent the first level of partitions. Clustering operations are typically performed based on one or more parameters, one of which may specify a desirable number of clusters into which the vectors are divided. As discussed herein, the first level of partitions can be imbalanced, such that certain partitions may include substantially larger (or smaller) number of vectors than other partitions. As such, the computer system may generate a second level of partitions to alleviate the imbalance in the first level of partitions.

For example, after generating the first level of partitions (e.g., by performing the clustering operation on the vectors), the computer system may perform another clustering operation on each of the partitions in the first level of partitions to generate a second level of partitions (also referred to as “sub-partitions”). In some embodiments, the computer system uses different parameters when performing the clustering operation on different partitions in the first level of partitions, such that the partitions may be further divided into different numbers of sub-partitions. When performing a clustering operation on a partition, the computer system may first determine a size of the partition (e.g., a number of vectors included in the partition). The computer system may then determine a parameter for performing the clustering operation on the vectors within the partition based on the parameter. For example, the computer system may determine a parameter that specifies a larger number of sub-partitions when the number of vectors within the partition is large (such that the vectors are divided into a larger number of sub-partitions), and may determine a parameter that specifies a smaller number of sub-partitions when the number of vectors within the partition is small (such that the vectors are divided into a smaller number of sub-partitions). For example, the computer system may determine a number of sub-partitions for a first-level partition to be the total number of vectors in the partition divided by the desired partition size. By varying the cluster parameters based on the size of each partition, the sub-partition sizes in the second level of partitions can be substantially even (e.g., within 5%, 10% of each other in size). The computer system may link each value corresponding to a partition in the first level of partitions to one or more sub-partitions in the second level of partitions.

The computer system may also generate a value (a representation) for each sub-partition in the second level of partitions (e.g., a centroid corresponding to the sub-partition). The computer system may also link, for each partition in the first level of partitions, the value representing the partitions to the values representing the corresponding sub-partitions in the index. In some embodiments, the computer system may continue to further divide the vectors into additional levels of sub-partitions (e.g., when the average number of vectors included within the partitions is larger than a threshold). When the computer system determines not to further divide the vectors into another level of partitions, the computer system may associate the vectors within the same sub-partition with the value representing the sub-partition (e.g., storing memory addresses of the vectors in association with the value representing the corresponding sub-partition).

When the AI model queries the vector database based on a prompt (or an input vector generated based on the prompt), the vector database may first compare the input vector against the values (e.g., the centroids, etc.) representing the first level of partitions within the index. Since the index is stored in the volatile memory, the comparison operations can be performed in memory without requiring loading of any data from a non-volatile memory to the volatile memory. The vector database may determine one or more first-level partitions that are related to the prompt based on the comparisons (e.g., selecting the top n number of centroids that are closest to the input vector, where n can be any number between 1 and the total number of partitions in the first level of partitions, selecting centroids that are within a threshold distance from the input vector, etc.). The vector database may then identify some of the sub-partitions (or second-level partitions) that are linked from the selected first-level partitions, and may compare the input vector against the values representing those second-level partitions within the index. Since the index is stored in the volatile memory, such an operation can also be performed in memory without requiring loading of any data from a non-volatile memory to the volatile memory. The vector database may select, from the identified second-level partitions, one or more second-level partitions that are related to the prompt (e.g., selecting the top m number of centroids that are closest to the input vector, where m can be any number between 1 and the total number of identified second-level partitions, selecting centroids that are within a threshold distance from the input vector, etc.).

Each of the identified second-level partitions may be associated with (e.g., may link to) one or more vectors of the vector database. As such, the vector database may retrieve, from the non-volatile memory, the one or more vectors that are linked from each of the identified second-level partitions (e.g., based on the memory addresses included in the index portion and linked to the selected second-level partitions). In some embodiments, the vector database may also rank the retrieved vectors based on comparing the vectors against the input vector, and may select one or more of the vectors that are closest to the input vectors. The vector database may provide the selected vectors to the AI model, such that the AI model may use the selected vectors to generate a response based on the prompt. Using the techniques disclosed herein, only a small portion of the vectors (vectors that are linked from the selected partitions determined to be related to the prompt) is required to be retrieved from the non-volatile memory to the volatile memory, which substantially reduces the amount of time required to transfer data between non-volatile memory and volatile memory. As such, the efficiency of the querying operation of a vector database is enhanced.

It is foreseeable that the AI model may grow its knowledge base over time. For example, the AI model may be retrained after being deployed. Through the retraining process, new vectors may be generated, and existing vectors in the vector database may be removed. In some embodiments, the vector database framework also provides techniques for efficiently managing the changes to the vector database (e.g., scaling up or scaling down, etc.). Since indexing of vectors would improve the querying performance of the vector database only when the number of vectors that are indexed exceeds a particular threshold, when new vectors are generated by the AI model, the vector database may initially store the new vectors in the volatile memory without indexing them. In some embodiments, the vector database includes a third portion-a non-indexed vector portion that stores the new vectors of the vector database that are not indexed. The vector database may store (or load) the non-indexed vector portion in the volatile memory. As new vectors are generated, the vector database may add the new vectors to the non-indexed vector portion of the vector database. During the querying operation, in addition to querying the index portion and the vector portion, as discussed herein, the vector database may also query the non-indexed vector portion. For example, the vector database may compare the input vector against each of the vector included in the non-indexed vector portion, and may select one or more vectors that are most similar to the input vector (e.g., closest to the input vector within the vector space). The response generated by the AI model may be based on both the vectors retrieved from the vector portion of the vector database and the vectors selected from the non-indexed vector portion of the vector database.

The vector database may continue to add new vectors to the non-indexed vector portion until the size of the non-indexed vector portion has reached a threshold (e.g., the particular threshold, etc.). When the vector database detects that the size of the non-indexed vector portion has reached (or has exceeded) the threshold, the vector database may perform the same indexing operation, as discussed herein, on the vectors in the non-indexed vector portion. For example, the vector database may generate a second index (or a second index portion) that represent a second set of partitions based on the vectors in the non-indexed vector portion, and may link each of the partition (or the value representing the partition) to different vectors from the non-indexed vector portion. The vector database may also store the second index (which may also include multiple levels of partitions) in the volatile memory and store the vectors (as a second vector portion) in the non-volatile memory (e.g., transferring the vectors from the volatile memory to the non-volatile memory). After storing the vectors in the non-volatile memory, the vector database may remove all of the vectors from the non-indexed vector portion of the vector database. New vectors that are generated by the AI model may subsequently add to the empty non-indexed vector portion.

As vectors are removed from the vector portion of the vector database, the size of the vector portion may be reduced. When the vector database detects that the size of a vector portion has reached (e.g., has fallen below) a threshold, the vector database may determine that it is no longer efficient to have the vectors in that vector portion indexed in the vector database (at this point, the partitions are likely to be imbalanced). As such, the vector database may move the vectors from that vector portion in the non-volatile memory to the non-indexed vector portion in the volatile memory. The vector database may also remove (e.g., delete) the corresponding index (or index portion) of the vector database. Accordingly, storing vectors in databases is more efficient, as querying large vector databases is quicker and maintenance of a database (e.g., removing old data, etc.) is easier compared to conventional systems and methods. In some embodiments, when the vector database detects that the size of one or more vector portions have fallen below a threshold, the vector database may merge these vector portions form a larger vector portion, and perform the same indexing operation on the new vector portion. During the merge operation, the vector database still uses the original small vector portions to serve queries. After the merge is complete and the new index is generated, the new vector portion replace the older (smaller) ones to serve queries and the older ones will be removed.

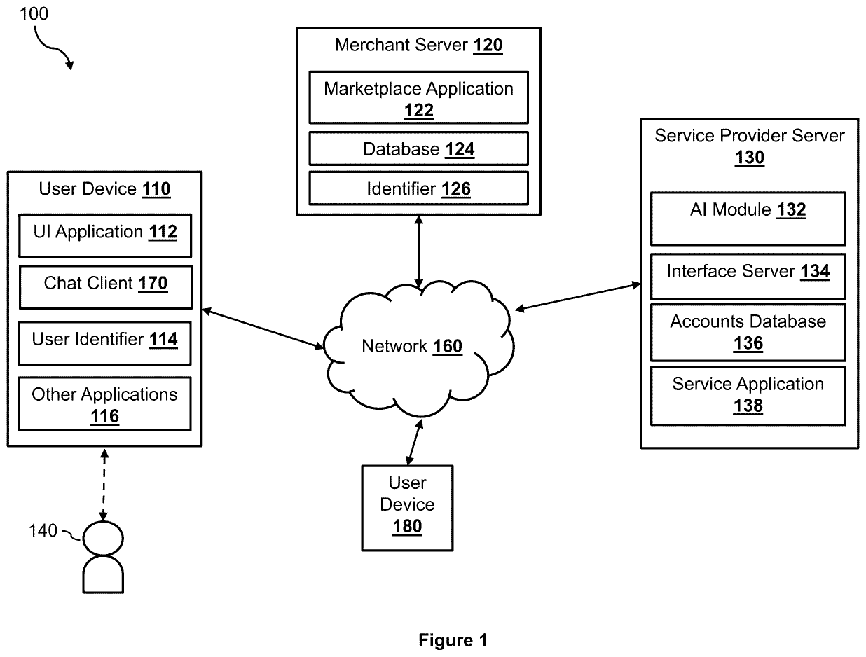

FIG. 1 illustrates an electronic transaction system 100, within which the vector database framework may be implemented according to one embodiment of the disclosure. The electronic transaction system 100 includes a service provider server 130, a merchant server 120, and user devices 110 and 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., data access, account transfers or payments, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130, as well as to see or hear progress and results of the transactions, such as via an AI module 132 of the service provider server 130.

The user device 110 may also include a chat client 170 for facilitating online chat sessions with another chat client (e.g., a chat client of another device, such as the user device 180, the AI module 132 of the service provider server 130, etc.). The chat client 170 may be a software application executed on the user device 110 for providing a chat client interface for the user 140 and for exchanging (e.g., transmitting and receiving) messages with the other chat client (either via a peer-to-peer chat protocol or via a chat server). For example, during an online chat session with the AI module 132, the chat client 170 may present a chat interface that enables the user 140 to input data (e.g., text data such as utterances, audio data, multi-media data, etc.) for transmitting to the AI module 132. The chat interface of the chat client 170 may also present messages that are received from the AI module 132. In some embodiments, the messages may be presented on the chat client interface in a chronological order according to a chat flow of the online chat session. The chat client 170 may be an embedded application that is embedded within another application, such as the UI application 112. Alternatively, the chat client 170 may be a stand-alone chat client program (e.g., a mobile app such as WhatsApp®, Facebook® Messenger, iMessages®, etc.) that is not associated with any other software applications executed on the user device 110.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 and/or the chat client 170 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, etc.). In another example, the user 140 may use the input component to interact with the chat client 170 (e.g., to provide utterances to be transmitted to other chat clients, to a chat server, etc.). The user 140 may transmit questions/inquiries, and/or requests for performing certain tasks/transactions using the input component. In some embodiments, if the chat client 170 is integrated within another application (e.g., the UI application 112, etc.), the chat client may automatically access account data of the user via a platform (e.g., a website, etc.) accessed by the UI application, and may provide the relevant account data to another chat client or a chat server for performing the tasks/transactions.

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items or services available for purchase in or access data from the merchant database 124. The merchant server 120, in one embodiment, may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes the AI module 132 that utilizes the vector database framework as discussed herein. In some embodiments, the AI module 132 may provide a user interface on devices (e.g., the user device 110, the user device 180, the merchant server 120, etc.) that enables users to interact with the AI module 132 (e.g., submit utterances, such as questions related to an organization associated with the service provider server 130, requests for performing a transaction, and/or receive information back from the service provider server 130, via the AI module 132, etc.). For example, the AI module 132 may include or have access to a chat server (not shown) that can facilitate and maintain chat sessions with different chat clients (e.g., the chat client 170, and other chat clients). The AI module 132 may use the chat server to establish chat sessions with different chat clients, and conduct conversations with different users via the chat sessions.

Based on the user inputs (e.g., utterances submitted by the user via a chat interface from voice or text), the AI module 132 may generate content in response to the user inputs. For example, when the user 140 of the user device 110 submits an utterance “how do I file a dispute for a transaction,” the AI module 132 may generate content (e.g., a response, etc.) related to instructions on how to file a dispute based on information related to the organization, and may transmit the generated content to the user via the chat interface as a response to the user inputs. In another example, when the user 140 of the user device 110 submits an utterance “I want to file a dispute for a transaction,” the AI module 132 may generate content (e.g., one or more prompts, etc.) that asks the user for information required to process a dispute (e.g., a selection of a particular transaction that the user wants to dispute, a reason for the dispute, etc.), and may process the transaction (e.g., the dispute transaction) for the user based on the information. While the AI module 132 is described as providing an automated chat service in the examples disclosed herein, it has been contemplated that the AI module 132 can also be used to perform other tasks, such as project management for the organization, management of different computer software modules, processing transactions, determining fraudulent transactions, etc.

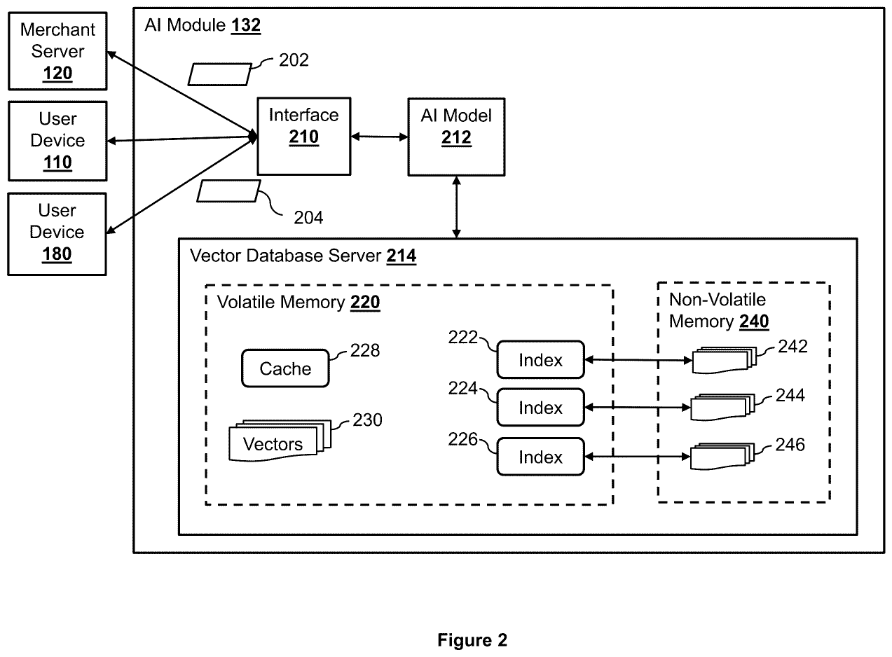

FIG. 2 illustrates a block diagram of the AI module 132 according to an embodiment of the disclosure. The AI module 132 includes an interface 210, an AI model 212, and a vector database server 214. In some embodiments, the AI model 212 is implemented as an artificial neural network that is configured to accept inputs (e.g., prompts) and to produce outputs (e.g., responses to the prompts) based on the inputs and information from the vector database server 214. For example, the inputs may be received from the merchant server 120, the user device 110, and/or the user device 180 via the interface 210.

In some embodiments, when the AI module 132 is configured to provide automated chat services to users, the chat interface 210 is configured to establish and/or maintain communication sessions (also referred to as “chat sessions”) with various chat clients of different user devices, such as the chat client 170 of the user device 110, a chat client of the merchant server 120, a chat client of the user device 180, etc. For example, when the user 140 uses the chat client 170 to initiate a chat session with the AI module 132, the interface 210 may establish a chat session with the chat client 170 using a particular protocol, which includes performing one or more handshakes with the chat client 170 to establish and assign a chat identifier to the chat session. The interface 210 may also maintain a communication with the chat client 170 until the chat session is terminated by either the AI module 132 or the chat client 170. As such, the AI module 132 may receive data (e.g., an utterance 202, etc.) from users of the service provider server 130 (e.g., the user 140) via the chat interface 210. The AI module 132 may generate a prompt for the AI model 212 based on the utterance 202. In some embodiments, the AI model 212 is configured to perform a task based on the prompt and the information from the vector database server 214, such as generating a response 204 to the utterance 202, etc. For example, the AI model 212 may query the vector database server 214 for information that is relevant to the prompt (e.g., information that contributes to generating a response to the prompt). In some embodiments, the AI model may convert the prompt into one or more input vectors, and may provide the input vectors to the vector database server 214.

The vector database server 214 may store vectors associated with information that forms the knowledge base for the AI model 212. In some embodiments, the information may be obtained by the AI model 212 through one or more training processes. For example, during a training process, data (e.g., articles, webpages, research papers, mathematical equations, etc.) may be provided to the AI model 212. The AI model 212 may generate vectors based on the data, and may store the vectors in the vector database server 214.

When the AI model 212 is requested to perform a task based on a prompt (e.g., the prompt generated based on the utterance 202, etc.), the AI model 212 may use at least some of the vectors from the vector database server 214 to perform the task. For example, the AI model 212 may generate a response 204 to the utterance 202 based on the information represented by some of the vectors stored in the vector database server 214.

As discussed herein, due to the complexity of the tasks that the AI model 212 is configured to perform, a large amount of information (represented as “vectors” or “embeddings”) is required by the AI model 212. In some embodiments, the vector database 214 uses the vector database framework as disclosed herein to manage the storage and querying of the vectors associated with the AI model 212. For example, the vector database server 214 may use one or more clustering techniques to generate one or more multi-level indices for the vectors. As shown, the vector database server 214 includes index portions 222, 224, and 226. Each of the index portions 222, 224, and 226 may include an index that represents partitions of vectors in a corresponding vector portion. For example, the index portion 222 includes an index that corresponds to a vector portion 242 that includes a set of vectors. The index portion 224 also includes an index that corresponds to a vector portion 244 that includes another set of vectors. The index portion 226 also includes an index that corresponds to a vector portion 246 that includes another set of vectors. The vector database 214 may also include other portions, such as a non-indexed vector portion 230 and a cache portion 228. The non-indexed vector portion 230 includes vectors that have not been indexed (e.g., due to the size of the vectors in the vector portion 230 being less than a threshold). The cache portion 228 stores some of the vectors from the vector portions 242, 244, and 246 that are frequently accessed.

In some embodiments, the vector database 214 stores these different portions in different physical memories to improve the storage and querying efficiency of the vector database 214. For example, the vector database 214 may store the index portions 222, 224, and 226, the non-indexed vector portion 230, and the cache portion 228 in a volatile memory 220 (e.g., a random access memory of the service provider server 130, etc.), while storing the vector portions 242, 244, and 246 in a non-volatile memory 240 (e.g., a solid-state drive coupled to the service provider sever 130, etc.). Since the index portions 222, 224, and 226, the cache portion 228, and the non-indexed vector portion 230 are accessed most frequently by the vector database 214, storing these portions in the volatile memory 220 improves the speed performance during each query operation of the vector database 214. In some embodiments, the AI model 212 is executed on the same volatile memory 220 that stores the index portions 222, 224, and 226, the non-indexed vector portion 230, and the cache 228 portion of the vector database 214, which further improves the speed performance of the vector database 214. In some embodiments, the vector database identifies one or more vectors that are relevant to the prompt (e.g., vectors that contribute to generating a response to the prompt) generated based on the utterance 202, and provides the one or more vectors to the AI model 212, such that the AI model 212 may perform the task (e.g., generating a response 204) based on the one or more vectors.

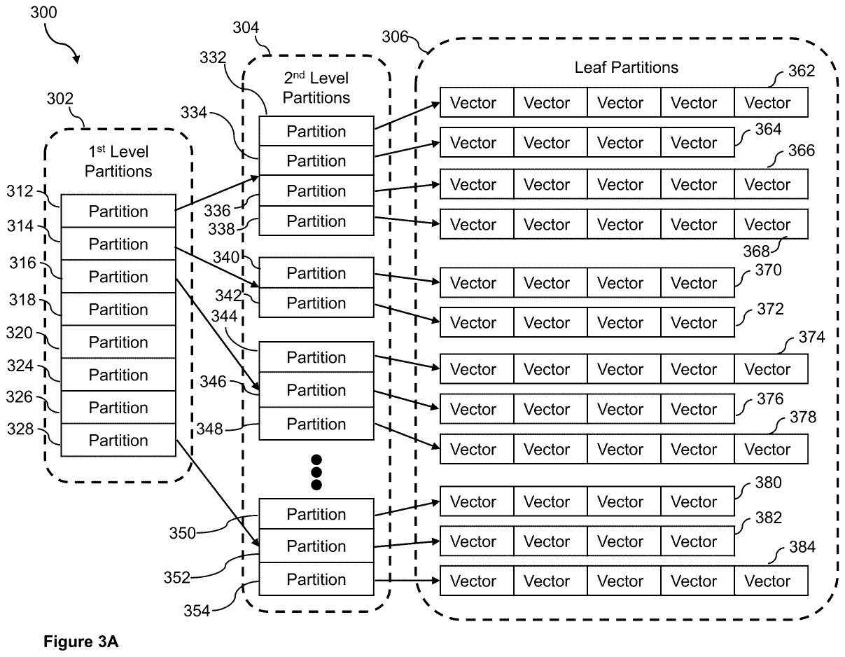

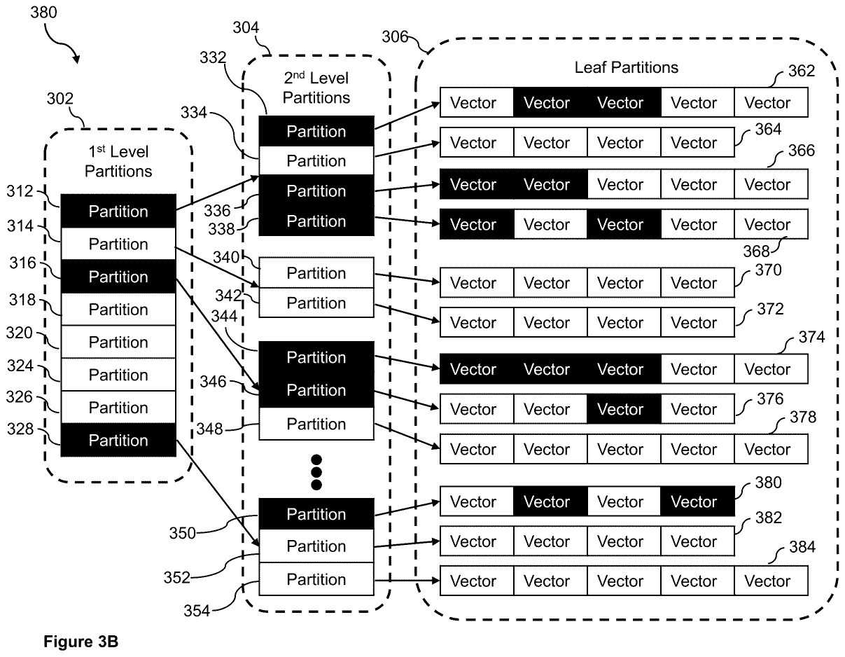

FIG. 3A illustrates an example multi-level indexing operation 300 of vectors according to various embodiments of the disclosure. As discussed herein, the vector database server 214 uses the vector database framework to manage the storage and querying of the vectors associated with the AI model 212. In some embodiments, the vector database server 214 generates a multi-level index for the vectors associated with the AI model 212 to facilitate efficient querying of the vectors. As the AI model 212 generates vectors that are part of the knowledge base for the AI model 212, the vector database server 214 may initially store the vectors in the non-indexed portion 230 of the vector database server 214. When the vectors are not indexed, each vector is required to be processed (e.g., compared against an input vector, etc.) during a query operation, which can consume a substantial amount of time and computer processing power. Indexing the vector may improve the query efficiency, but require time and computer processing resources to perform the initial indexing operation. As the size of the vectors has reached a threshold, the benefits of an indexed vector may outweigh the initial computation cost of the indexing operation.

As such, when the vector database server 214 detects that the size of the vectors in the non-indexed portion 230 has reached a threshold, the vector database server 214 may perform an indexing operation on the vectors in the non-indexed portion 230 to generate a new index (e.g., a new index portion) for the vectors. In some embodiments, the vector database server 214 may use one or more clustering techniques to generate a multi-level index for the vectors. For example, the vector database server 214 may perform a first clustering operation to divide the vectors into a first level of partitions 302. In this example, the vector database server 214 may divide the vectors into eight partitions 312, 314, 316, 318, 320, 324, 326, and 328 based on a parameter determined for the clustering operation. Each of the partitions 312, 314, 316, 318, 320, 324, 326, and 328 may include a distinct set of vectors. In some embodiments, the vector database server 214 also generates a representation for each of the partitions 312, 314, 316, 318, 320, 324, 326, and 328. For example, since each partition includes vectors that are within a cluster based on the clustering operation, the vector database server 214 may determine a centroid of the cluster, and use the centroid as the representation for each partition.

As discussed herein, it is possible that the partitions 312, 314, 316, 318, 320, 324, 326, and 328 are not evenly balanced. In other words, some of the partitions in the first level partitions 302 may include substantially more vectors than other partitions in the first level of partitions 302. In some embodiments, the vector database server 214 performs second clustering operations to further divide the vectors in each partition of the first level partitions 302 into a second level of partitions 304, such that the partitions are substantially balanced (e.g., each partition is within 5%, 10% of each other in size, etc.). Specifically, the vector database server 214 may configure the clustering operation differently for each partition in the first level partitions 302, such that different partitions in the first level partitions 302 may be divided into different numbers of partitions in the second level of partitions 304. The vector database server 214 may configure the clustering operation to divide a partition in the first level of partitions 302 into a larger number of partitions when the partition has a larger amount of vectors, and may configure the clustering operation to divide a partition in the first level of partitions 302 into a smaller number of partitions when the partition has a smaller amount of vectors. In a non-limiting example, the vector database server 214 may determine a desirable partition size for each partition in the second level of partitions 304, and may determine the parameter for the clustering operation based on the partition size, such that the clustering operation divides the vectors into partitions that are substantially similar to (e.g., within 95%, 90%, etc.) the desired partition size (e.g., parameter (number of partitions)=total number of vectors in the partition/the desired partition size). If a partition of the first level partition 302 already has the desired partition size (e.g., has a desired number of vectors), the vector database server 214 may not perform a clustering operation on that partition.

In this example, the vector database server 214 has divided the partition 312 into four partitions 332, 334, 336, and 338. The vector database server 214 has also divided the partition 314 into two partitions 340 and 342 (due to the number of vectors in the partition 314 being smaller than the number of vectors in the partition 312). The vector database server 214 has also divided the partition 316 into three partitions 344, 346, and 348 (due to the number of vectors in the partition 316 being smaller than the number of vectors in the partition 312 but larger than the number of vectors in the partition 314). The vector database server 214 has also divided the partition 328 into three partitions 350, 352, and 354. The vector database server 214 may also link each partition in the first level of partitions 302 to its corresponding second level of partitions, such that the vector database server 214 may access the corresponding second level of partitions from each partition in the first level of partitions 302. For example, the vector database server 214 may associate the representations of the partitions 332, 334, 336, and 338 with the representation of partition 312 in the index. The vector database server 214 may also associate the representations of the partitions 340 and 342 with the representation of the partition 314 in the index. The vector database server 214 may also associate the representations of the partitions 344, 346, and 348 with the representation of the partition 316 in the index. The vector database server 214 may also associate the representations of the partitions 350, 352, and 354 with the representation of the partition 328 in the index.

Each of the partition in the second level partitions 304 may include a distinct group of vectors. For example, the partition 332 includes a vector group 362 that includes five vectors, the partition 334 includes a vector group 364 that includes four vectors, the partition 336 includes a vector group 366 that includes five vectors, the partition 338 includes a vector group 368 that includes five vectors, the partition 340 includes a vector group 370 that includes four vectors, the partition 342 includes a vector group 372 that includes four vectors, the partition 344 includes a vector group 374 that includes five vectors, the partition 346 includes a vector group 376 that includes four vectors, the partition 348 includes a vector group 378 that includes five vectors, the partition 350 includes a vector group 380 that includes four vectors, the partition 352 includes a vector group 382 that includes four vectors, and the partition 354 includes a vector group 384 that includes five vectors. Similar to the first level partitions 302, the vector database server 304 may also generate a representation for each partition in the second level partitions 304. For example, the vector database server 304 may also determine a centroid of a cluster of vectors corresponding to each partition, and store the centroid in the partition as a representation of the partition.

The vector database server 214 may store the vectors that have been indexed in the non-volatile memory 240 as a new vector portion 306. In some embodiments, in order to further enhance the speed performance of the vector database server 214, the vector database server 214 may store vectors that are within the same group (e.g., associated with the same partition) close together in the non-volatile memory 240 (e.g., within the same block or consecutive blocks of the non-volatile memory 240). The vectors database server 214 may also link the vectors (e.g., memory addresses in the non-volatile memory associated the vectors) within the same group with the corresponding partition (e.g., associating the addresses with the representation of the corresponding partition). For example, the vector database server 214 may associate the memory addresses of the vectors in the vector group 362 with the representation of the partition 332 in the index. The vector database server 214 may also store information associated with the vectors in the vector group 364 (e.g., memory addresses of the vectors, etc.) in association with the representation of the partition 334 in the index. The vector database server 214 may also store information associated with the vectors in the vector group 366 (e.g., memory addresses of the vectors, etc.) in association with the representation of the partition 336 in the index. The vector database server 214 may also store information associated with the vectors in the vector group 368 (e.g., memory addresses of the vectors, etc.) in association with the representation of the partition 338 in the index. The vector database server 214 may also store information associated with the vectors in the vector group 370 (e.g., memory addresses of the vectors, etc.) in association with the representation of the partition 340 in the index. The vector database server 214 may also store information associated with the vectors in the vector group 372 (e.g., memory addresses of the vectors, etc.) in association with the representation of the partition 342 in the index. The vector database server 214 may also store information associated with the vectors in the vector group 374 (e.g., memory addresses of the vectors, etc.) in association with the representation of the partition 344 in the index. The vector database server 214 may also store information associated with the vectors in the vector group 376 (e.g., memory addresses of the vectors, etc.) in association with the representation of the partition 346 in the index. The vector database server 214 may also store information associated with the vectors in the vector group 378 (e.g., memory addresses of the vectors, etc.) in association with the representation of the partition 348 in the index. The vector database server 214 may also store information associated with the vectors in the vector group 380 (e.g., memory addresses of the vectors, etc.) in association with the representation of the partition 350 in the index. The vector database server 214 may also store information associated with the vectors in the vector group 382 (e.g., memory addresses of the vectors, etc.) in association with the representation of the partition 352 in the index. The vector database server 214 may also store information associated with the vectors in the vector group 384 (e.g., memory addresses of the vectors, etc.) in association with the representation of the partition 354 in the index.

After generating the index (e.g., including the first level partition 302 and the second level partition 304) for the vectors, the vector database server 214 may store the index as a new index portion in the volatile memory 220. The vector database server 214 may also delete the vectors from the non-indexed portion 230 from the volatile memory 220. As new vectors are generated by the AI model 212, the vector database server 214 may start storing the new vectors in the non-indexed portion 230 again.

FIG. 3B illustrates an example querying operation 380 on vectors that have been indexed using a multi-level indexing operation according to various embodiments of the disclosure. The AI module 132 may receive requests to perform tasks from different devices. The requests may be in the form of utterances, such as the utterance 202. The AI module 132 may generate a prompt based on the utterance 202, and provide the prompt to the AI model 212. In order for the AI model 212 to perform the task (e.g., generating a response 204 for the utterance 202, etc.), the AI model 212 needs to access information that is relevant (e.g., information that contributes to generating a response to the prompt) to the prompt, and that can be used by the AI model 212 to perform the task. As such, the AI model 212 may query the vector database server 214 using the prompt. In some embodiments, the AI model 212 may first generate one or more input vectors based on the prompt (e.g., converting contents from the prompt into one or more vectors that represent the contents), and provide the input vectors to the vector database server 214.

The vector database server 214 may be configured to identify one or more vectors that is stored within the vector database server 214 based on the input vectors (e.g., one or more vectors that are closest to an input vector within the vector space, etc.), and provide the one or more vectors to the AI model 212. In some embodiments, the vector database server 214 may access an index portion that includes multiple levels of partitions (e.g., the first level partitions 302 and the second level partitions 304) from the volatile memory 220. The vector database server 214 may first compare the input vector against the representation of each partition in the first level partitions 302. Since the representations correspond to the centroids of the clusters of vectors, the vector database server 214 may determine that the more similar (e.g., closer) between the input vector and a representation, the more similar they are between the input vector and the vectors within the corresponding partition. As such, the vector database server 214 may select one or more partitions from the first level partitions 302 that are closest (e.g., most similar) to the input vector. In this example, the vector database server 214 has determined that the partitions 312, 316, and 328 are closest to the input vector based on the comparison.

The vector database server 214 may then access partitions from the second level partitions 304 that are linked from the selected partitions 312, 316, and 328. For example, the vector database server 214 may determine that the partition 312 links to the partitions 332, 334, 336, and 338, that the partition 316 links to the partitions 344, 346, and 348, and that the partition 328 links to the partitions 350, 352, and 354. The vector database server 214 may again compare the input vector against the representations of the linked second level partitions 332, 334, 336, 338, 344, 346, 348, 350, 352, and 354, and may determine one or more of the second level partitions that are closest (e.g., most similar) to the input vector. In this example, the vector database server 214 may determine that the partitions 332, 336, 338, 344, 346, and 350 are most similar to the input vector.

The vector database server 214 may then access the groups of vectors associated with the partitions 332, 336, 338, 344, 346, and 350 from the non-volatile memory 240, such as the vector groups 362, 366, 368, 374, 376, and 380 (e.g., loading the vector groups 362, 366, 368, 374, 376, and 380 from the non-volatile memory 240 to the volatile memory 220). The vector database server 214 may also compare the input vector against the vectors within the vector groups 362, 366, 368, 374, 376, and 380, and may determine one or more vectors that are closest (e.g., most similar) to the input vector. The vector database server 214 may then return the selected one or more vectors to the AI model 212, such that the AI model 212 can use the selected vectors for performing the task. In some embodiments, the vector database server 214 also stores the selected vectors in the cache portion 228. For example, the vector database server 214 may store the vector groups that are accessed most frequently in the cache portion 228 (e.g., a LRU cache). If the seed vector hit the vector group in the cache portion 228, the vector database server may retrieve the vector group directly from the cache portion 228, without loading the vector group from the non-volatile memory 240. As illustrated in this example, by using the vector database framework disclosed herein that provides multi-level of indexing and split storage of the index portion and the vector portion, the vector database server 214 is only required to access the non-volatile memory 240 (which provides slower access time) for a small portion of the vectors during a query operation, thereby improving the speed performance of the vector database server 214.

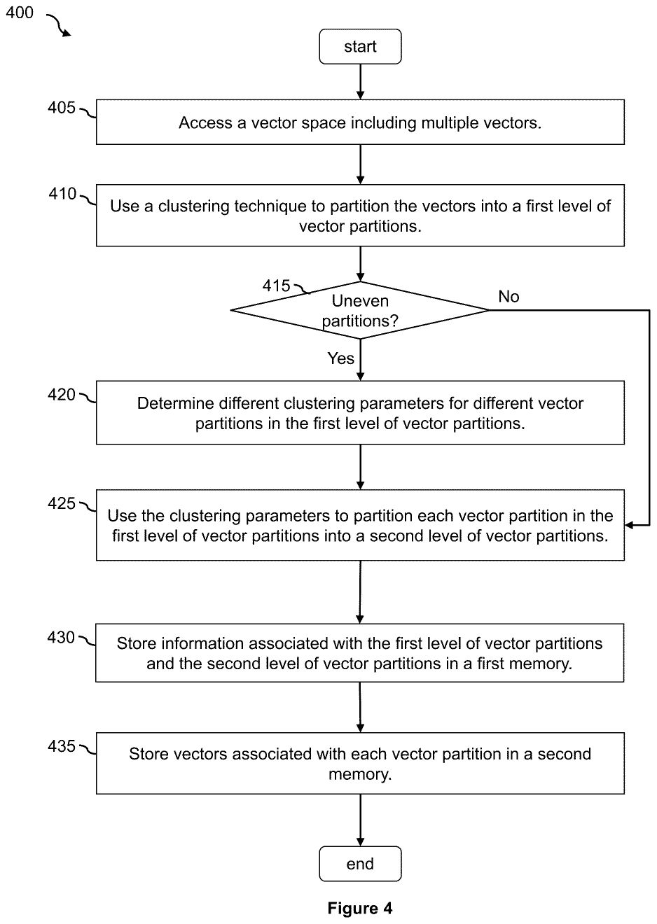

FIG. 4 illustrates a process 400 for generating a vector database according to various embodiments of the disclosure. In some embodiments, at least a portion of the process 400 may be performed by the AI module 132, although one or more steps may be performed by one or more of the components/devices/modules/systems described herein. The process 400 begins by accessing (at step 405) a vector space including multiple vectors. For example, the AI model 212 may generate vectors during one or more training processes of the AI model 212. As the AI model 212 generates new vectors, the vector database server 214 may store the vectors in the non-indexed vector portion 230.

At step 410, the vector database server 214 uses a clustering technique to partition the vectors into a first level of vector partitions. For example, when the vector database server 214 determines that the number of vectors in the non-indexed vector portion 230 has reached a threshold, the vector database server 214 may perform an indexing operation on the vectors. In some embodiments, the vector database server 214 uses one or more clustering technique to partition the vectors into multiple partitions (e.g., first level partitions 302).

The vector database server 214 then determines (at step 415) whether the partitions are uneven. For example, the vector database server 214 may determine that the partitions are uneven when the sizes of the partitions deviate more than a threshold (e.g., 10%, 20%, etc.). If the vector database server 214 determines that the partitions are uneven, the vector database server 214 determines (at step 420) different clustering parameters for different vector partitions in the first level of vector partitions. For example, the vector database server 214 may determine a clustering parameter for each vector partition based on the size (e.g., the number of vectors) of the vector partition, such that a clustering parameter that specifies a larger number of partitions is determined for a larger vector partition, and a clustering parameter that specifies a smaller number of partitions is determined for a smaller vector partition.

If the vector database server 214 determines that the partitions are not uneven, the vector database server 214 may determine the same clustering parameter for all of the partitions.

The vector database server 214 then uses (at step 425) the clustering parameters to partition each vector partition in the first level of partitions into a second level of partitions. For example, the vector database server 214 may perform a cluster operation based on the corresponding clustering parameter on each partition in the first level partition 302. If different clustering parameters are used, different partitions are divided into different numbers of partitions in the second level of partitions.

The vector database server 214 may also generate an index based on the first level of partitions and the second level of partitions. For example, the vector database server 214 may generate a representation for each partition (e.g., a centroid of a corresponding vector cluster), and store the representation in the partition. The vector database server 214 may also link each partition in the first level partitions 302 to the corresponding second level partitions.

After generating the index, the vector database server 214 stores (at step 430) the index (including information associated with the first level of partitions and the second level of partitions in a first memory (e.g., the volatile memory 220), and stores (at step 435) the vectors associated with each vector partition in a second memory (e.g., the non-volatile memory 240).

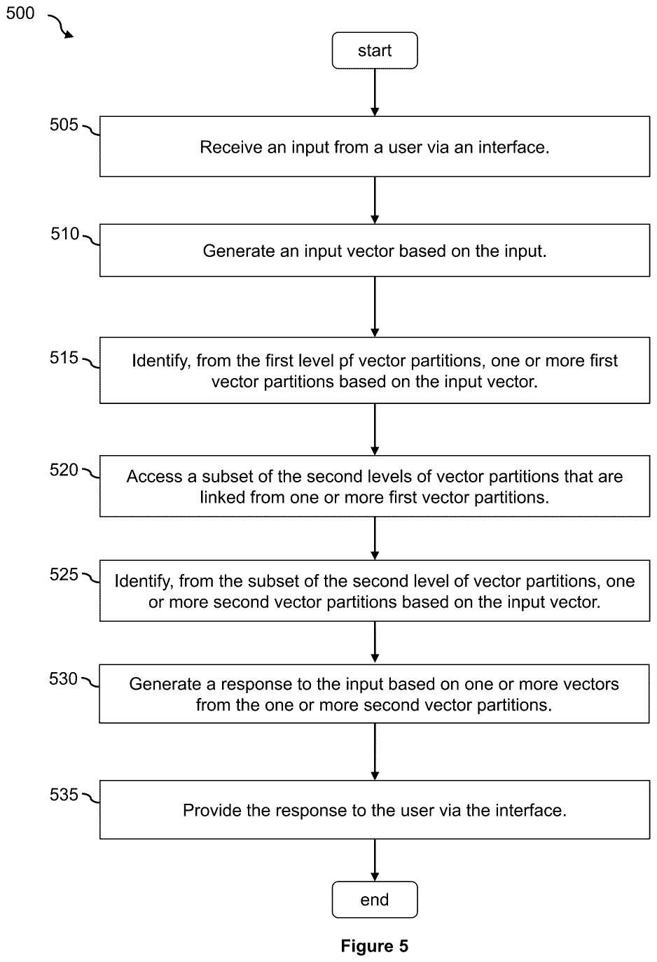

FIG. 5 illustrates a process 500 for querying a vector database according to various embodiments of the disclosure. In some embodiments, at least a portion of the process 500 may be performed by the AI module 132, although one or more steps may be performed by one or more of the components/devices/modules/systems described herein. The process 500 begins by receiving (at step 505) an input from a user via an interface. For example, the AI module 132 may receive an input from the merchant server 120, the user device 110, and/or the user device 180. The input may be provided in different formats. If the AI module 132 is configured to facilitate a chat session with a user, the input may include an utterance provided by the user. In other examples, the input may include instructions, programming code, or any other formats.

In some embodiments, the AI module 132 generates a prompt for the AI model 212 based on the input. The prompt may include additional information such as a context associated with the chat session, etc. Based on the prompt, the AI model 212 generates (at step 510) an input vector. The AI model 212 may provide the input vector to the vector database server 214 to retrieve relevant information (vectors) that can be used by the AI model 212 to perform the task based on the prompt.

In some embodiments, the vector database server 214 may use the multi-level index system to retrieve the relevant vectors for the AI model 212. For example, the vector database server 214 may access an index portion from a volatile memory (e.g., the volatile memory 220). The index portion includes multiple levels of partitions. The vector database server 214 may access a first level of partitions. The vector database server 214 then identifies (at step 515), from the first level of vector partitions, one or more first vector partitions based on the input vector. For example, the vector database server 214 may compare the input vector against the representation of each partition in the first level of partitions, and select one or more partitions that are most similar to the input vector, such as the closest distance-wise to the input vector or other similarity metrics.

The vector database server 214 then accesses (at step 520) a subset of the second level of vector partitions that are linked from the one or more first vector partitions and identifies (at step 525), from the subset of the second level of vector partitions, one or more second vector partitions based on the input vector. For example, the vector database server 214 may access some of the second level partitions that are linked from the identified first level partitions in the volatile memory 220. Based on the second level partitions, the vector database server 214 may identifies vectors associated with the second level partitions and stored in the non-volatile memory 240. For example, each second level partition may include memory locations of the vectors stored in the non-volatile memory 240 (e.g., memory block addresses, etc.). The vector database server 214 may retrieve (or load) the identified vectors from the non-volatile memory 240 to the volatile memory 220. For example, the vector database may determine whether the identified vector is stored in the cache portion 228, and may retrieve the identified vector from the cache portion 228 if the identified vector is part of a vector group that has been stored in the cache portion 228. Otherwise, the vector database may load the identified vector from non-volatile memory 240, and save it in cache portion 228 (LRU cache) to serve the subsequent queries. The vector database server 214 may provide the vectors to the AI model 212.

The AI model 212 then generates (at step 530) a response to the input based on one or more vectors from the one or more second vector partition. The AI module 132 provides (at step 535) the response to the user via the interface.

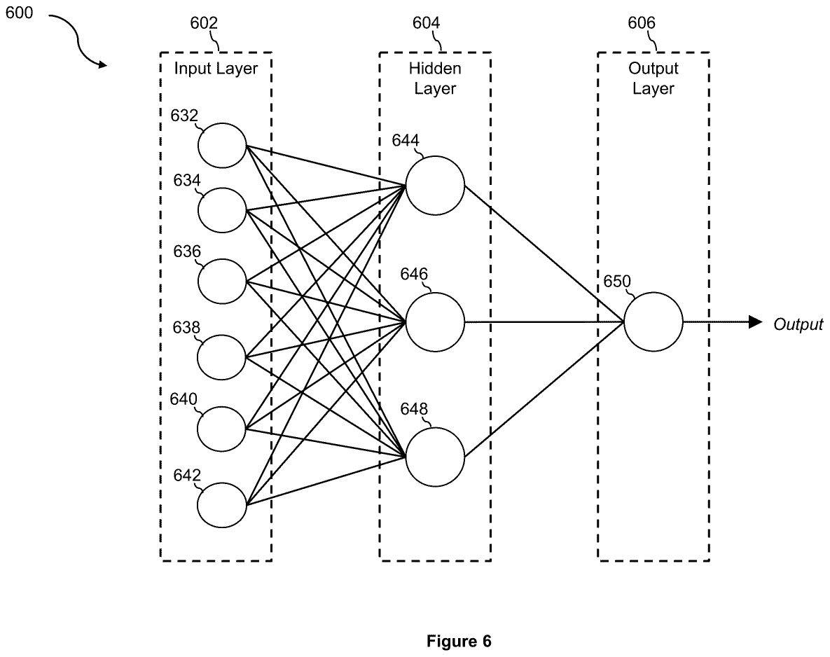

FIG. 6 illustrates an example artificial neural network 600 that may be used to implement a machine learning model, such as the AI model 212 associated with the AI module 132. As shown, the artificial neural network 600 includes three layers—an input layer 602, a hidden layer 604, and an output layer 606. Each of the layers 602, 604, and 606 may include one or more nodes (also referred to as “neurons”). For example, the input layer 602 includes nodes 632, 634, 636, 638, 640, and 642, the hidden layer 604 includes nodes 644, 646, and 648, and the output layer 606 includes a node 650. In this example, each node in a layer is connected to every node in an adjacent layer via edges and an adjustable weight is often associated with each edge. For example, the node 632 in the input layer 602 is connected to all of the nodes 644, 646, and 648 in the hidden layer 604. Similarly, the node 644 in the hidden layer is connected to all of the nodes 632, 634, 636, 638, 640, and 642 in the input layer 602 and the node 650 in the output layer 606. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 604 is an intermediate layer between the input layer 602 and the output layer 606 of the artificial neural network 600. Although only one hidden layer is shown for the artificial neural network 600 for illustrative purpose only, it has been contemplated that the artificial neural network 600 used to implement any one of the computer-based models may include as many hidden layers as necessary. The hidden layer 604 is configured to extract and transform the input data received from the input layer 602 through a series of weighted computations and activation functions.

In this example, the artificial neural network 600 receives a set of inputs and produces an output. Each node in the input layer 602 may correspond to a distinct input. For example, when the artificial neural network 600 is used to implement the AI model 212, the nodes in the input layer 602 may correspond to different parameters and/or attributes of a prompt (which may be generated based on the utterance 202 and other information).

In some embodiments, each of the nodes 644, 646, and 648 in the hidden layer 604 generates a representation, which may include a mathematical computation (or algorithm) that produces a value based on the input values received from the nodes 632, 634, 636, 638, 640, and 642. The mathematical computation may include assigning different weights (e.g., node weights, edge weights, etc.) to each of the data values received from the nodes 632, 634, 636, 638, 640, and 642, performing a weighted sum of the inputs according to the weights assigned to each connection (e.g., each edge), and then applying an activation function associated with the respective node (or neuron) to the result. The nodes 644, 646, and 648 may include different algorithms (e.g., different activation functions) and/or different weights assigned to the data variables from the nodes 632, 634, 636, 638, 640, and 642 such that each of the nodes 644, 646, and 648 may produce a different value based on the same input values received from the nodes 632, 634, 636, 638, 640, and 642. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 602 is transformed into rather different values indicative data characteristics corresponding to a task that the artificial neural network 600 has been designed to perform.

In some embodiments, the weights that are initially assigned to the input values for each of the nodes 644, 646, and 648 may be randomly generated (e.g., using a computer randomizer). The values generated by the nodes 644, 646, and 648 may be used by the node 650 in the output layer 606 to produce an output value (e.g., a response to a user query, a prediction, etc.) for the artificial neural network 600. The number of nodes in the output layer depends on the nature of the task being addressed. For example, in a binary classification problem, the output layer may consist of a single node representing the probability of belonging to one class (as in the example shown in FIG. 6). In a multi-class classification problem, the output layer may have multiple nodes, each representing the probability of belonging to a specific class. When the artificial neural network 600 is used to implement the AI model 212, the output node 650 may be configured to generate new content (e.g., a response in a natural language format, instructions for the backend modules, etc.) based on the prompt.

In some embodiments, the artificial neural network 600 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 600 may be trained by using training data based on one or more loss functions and one or more hyperparameters. By using the training data to iteratively train the artificial neural network 600 through a feedback mechanism (e.g., comparing an output from the artificial neural network 600 against an expected output, which is also known as the “ground-truth” or “label”), the parameters (e.g., the weights, bias parameters, coefficients in the activation functions, etc.) of the artificial neural network 600 may be adjusted to achieve an objective according to the one or more loss functions and based on the one or more hyperparameters such that an optimal output is produced in the output layer 606 to minimize the loss in the loss functions. Given the loss, the negative gradient of the loss function is computed with respect to each weight of each layer individually. Such negative gradient is computed one layer at a time, iteratively backward from the last layer (e.g., the output layer 606 to the input layer 602 of the artificial neural network 600). These gradients quantify the sensitivity of the network's output to changes in the parameters. The chain rule of calculus is applied to efficiently calculate these gradients by propagating the gradients backward from the output layer 606 to the input layer 602.

Parameters of the artificial neural network 600 are updated backwardly from the last layer to the input layer (backpropagating) based on the computed negative gradient using an optimization algorithm to minimize the loss. The backpropagation from the last layer (e.g., the output layer 606) to the input layer 602 may be conducted for a number of training samples in a number of iterative training epochs. In this way, parameters of the artificial neural network 600 may be gradually updated in a direction to result in a lesser or minimized loss, indicating the artificial neural network 600 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

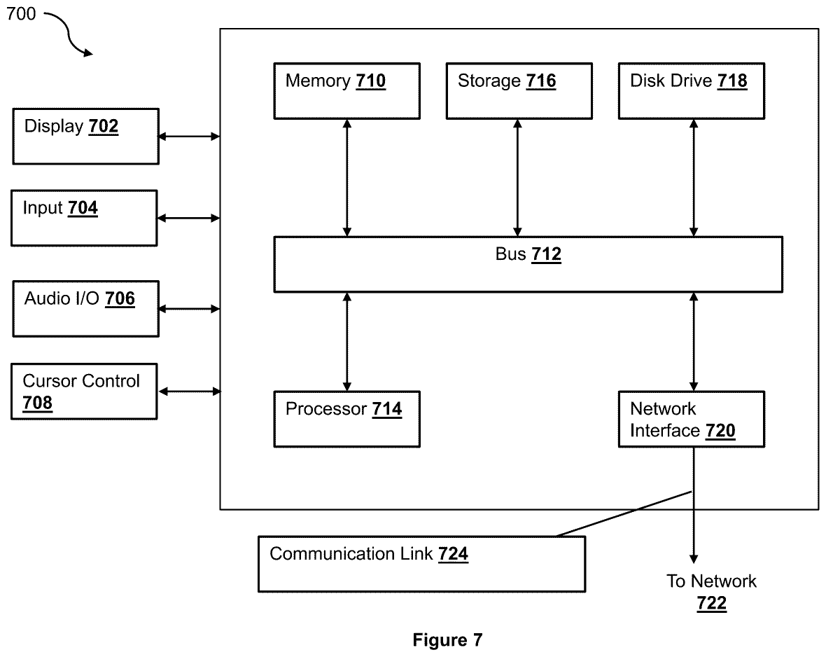

FIG. 7 is a block diagram of a computer system 700 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 700 in a manner as follows.

The computer system 700 includes a bus 712 or other communication mechanism for communicating information data, signals, and information between various components of the computer system 700. The components include an input/output (I/O) component 704 that processes a user (i.e., sender, recipient, service provider) action, such as selecting keys from a keypad/keyboard, selecting one or more buttons or links, etc., and sends a corresponding signal to the bus 712. The I/O component 704 may also include an output component, such as a display 702 and a cursor control 708 (such as a keyboard, keypad, mouse, etc.). The display 702 may be configured to present a login page for logging into a user account or a checkout page for purchasing an item from a merchant. An optional audio input/output component 706 may also be included to allow a user to use voice for inputting information by converting audio signals. The audio I/O component 706 may allow the user to hear audio. A transceiver or network interface 720 transmits and receives signals between the computer system 700 and other devices, such as another user device, a merchant server, or a service provider server via a network 722. In one embodiment, the transmission is wireless, although other transmission mediums and methods may also be suitable. A processor 714, which can be a micro-controller, digital signal processor (DSP), or other processing component, processes these various signals, such as for display on the computer system 700 or transmission to other devices via a communication link 724. The processor 714 may also control transmission of information, such as cookies or IP addresses, to other devices.

The components of the computer system 700 also include a system memory component 710 (e.g., RAM), a static storage component 716 (e.g., ROM), and/or a disk drive 718 (e.g., a solid-state drive, a hard drive). The computer system 700 performs specific operations by the processor 714 and other components by executing one or more sequences of instructions contained in the system memory component 710. For example, the processor 714 can perform the vector database functionalities described herein, for example, according to the processes 400 and 600.

Logic may be encoded in a computer readable medium, which may refer to any medium that participates in providing instructions to the processor 714 for execution. Such a medium may take many forms, including but not limited to, non-volatile media, volatile media, and transmission media. In various implementations, non-volatile media includes optical or magnetic disks, volatile media includes dynamic memory, such as the system memory component 710, and transmission media includes coaxial cables, copper wire, and fiber optics, including wires that comprise the bus 712. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 700. In various other embodiments of the present disclosure, a plurality of computer systems 700 coupled by the communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
in response to receiving an input, generate an input vector based on the input;
query a vector database using the input vector, wherein the vector database comprises (i) an index portion stored in a volatile memory of the system and (ii) a vector portion including a plurality of vectors stored in a non-volatile memory of the system, wherein querying the vector database comprises:
accessing the index portion from the volatile memory of the system;
identifying, from the plurality of vectors, one or more vectors that are relevant to the input based on the input vector and the index portion of the vector database; and
retrieving the one or more vectors from the non-volatile memory of the system; and
provide a response to the input based on the one or more vectors.

2. The system of claim 1, wherein the index portion comprises an index that represents a first level of vector partitions and a second level of vector partitions, and wherein each vector partition in the first level of vector partitions corresponds to a different subset of the second level of vector partitions.

3. The system of claim 2, wherein the plurality of vectors is divided into the first level of vector partitions based on a first clustering process performed on the plurality of vectors, wherein vectors within each vector partition of the first level of vector partitions are further divided into a subset of vector partitions in the second level of vector partitions based on a second clustering process performed on the vectors.

4. The system of claim 3, wherein the second clustering process is performed on each corresponding vector partition in the first level of vector partitions using a corresponding parameter determined based on a number of vectors associated with the corresponding vector partition, and wherein the corresponding parameter specifies a number of vector partitions into which the corresponding vector partition is divided.

5. The system of claim 2, wherein the querying the vector database further comprises:
identifying, from the first level of vector partitions, a first vector partition for the input based on comparing the input vector against first representations associated with the first level of vector partitions, wherein the first vector partition is linked to a first subset of vector partitions in the second level of vector partitions;
identifying, from first subset of vector partitions in the second level of vector partitions, a second vector partition for the input based on comparing the input vector and second representations associated with the first subset of vector partitions, wherein the second vector partition comprises a subset of vectors from the plurality of vectors;
identifying, from the subset of vectors, one or more vectors for the input based on comparing the input vector against the subset of vectors; and
generating the response based on the one or more vectors.

6. The system of claim 1, wherein the non-volatile memory is a solid-state drive memory.

7. The system of claim 1, wherein the vector database further comprises a non-indexed vector portion stored in the volatile memory, wherein the non-indexed vector portion comprises a second plurality of vectors that is not indexed.

8. A method comprising:
accessing, by a computer system, an input vector generated by an artificial intelligence (AI) model based on an input;
querying, by the computer system, a vector database using the input vector, wherein the vector database comprises (i) an index portion stored in a volatile memory of the computer system and (ii) a vector portion including a plurality of vectors stored in a non-volatile memory of the computer system, wherein the querying the vector database comprises:
accessing the index portion from the volatile memory of the computer system;
identifying, from the plurality of vectors, one or more vectors for the AI model based on the input vector and the index portion of the vector database; and
retrieving the one or more vectors from the non-volatile memory of the computer system; and
causing, by the computer system, the AI model to generate a response to the input based on the one or more vectors.

9. The method of claim 8, wherein the vector database further comprises a non-indexed vector portion stored in the volatile memory, and wherein the non-indexed vector portion comprises a second plurality of vectors that is not indexed.

10. The method of claim 9, wherein the querying the vector database further comprises comparing the input vector with each of the second plurality of vectors in the non-indexed vector portion.

11. The method of claim 8, further comprising:
obtaining an additional vector generated by the AI model; and
storing the additional vector in the non-indexed vector portion of the vector database.

12. The method of claim 8, further comprising:
determining that a size of the second plurality of vectors in the non-indexed vector portion exceeds a size threshold; and
generating a second index for the vector database based on indexing the second plurality of vectors.

13. The method of claim 8, wherein the index portion comprises an index that represents a first level of vector partitions and a second level of vector partitions, and wherein each vector partition in the first level of vector partitions corresponds to a different subset of the second level of vector partitions.

14. The method of claim 13, wherein the plurality of vectors is divided into the first level of vector partitions based on a first clustering process performed on the plurality of vectors, wherein vectors within each vector partition of the first level of vector partitions are further divided into a subset of vector partitions in the second level of vector partitions based on a second clustering process performed on the vectors.

15. A non-transitory machine-readable medium having stored thereon machine-readable instructions executable to cause a machine to perform operations comprising:
obtaining an input vector generated by an artificial intelligence (AI) model;
querying a vector database using the input vector, wherein the vector database comprises (i) an index portion stored in a volatile memory and (ii) a vector portion including a plurality of vectors stored in a non-volatile memory, wherein the querying the vector database comprises:
accessing the index portion from the volatile memory;
identifying, from the plurality of vectors, one or more vectors that are relevant to the input vector based on the input vector and the index portion of the vector database; and
retrieving the one or more vectors from the non-volatile memory; and
causing the AI model to generate data based on the one or more vectors.

16. The non-transitory machine-readable medium of claim 15, wherein the operations further comprise:
receiving, via an interface, an input from a device, wherein the input vector is generated based on the input; and
transmitting the data to the device via the interface as a response to the input.

17. The non-transitory machine-readable medium of claim 15, wherein the vector database further comprises a non-indexed vector portion stored in the volatile memory, and wherein the non-indexed vector portion comprises a second plurality of vectors that is not indexed.

18. The non-transitory machine-readable medium of claim 17, wherein the querying the vector database further comprises comparing the input vector with each of the second plurality of vectors in the non-indexed vector portion.

19. The non-transitory machine-readable medium of claim 15, wherein the index portion comprises an index that represents a first level of vector partitions and a second level of vector partitions, and wherein each vector partition in the first level of vector partitions corresponds to a different subset of the second level of vector partitions.

20. The non-transitory machine-readable medium of claim 19, wherein the plurality of vectors is divided into the first level of vector partitions based on a first clustering process performed on the plurality of vectors, wherein vectors within each vector partition of the first level of vector partitions are further divided into a subset of vector partitions in the second level of vector partitions based on a second clustering process performed on the vectors.
